(19) United States
(12) Patent Application Publication
(10) Pub. No.: US 2003/0223640 A1
(43) Pub. Date: Dec. 4, 2003

(54) Apparatus, methods, computer program products for editing handwritten symbols using alternative known symbols

(76) Inventor: Daniel P. Homiller, Cary, NC (US)

Correspondence Address: MYERS BIGEL SIBLEY & SAJOVEC, PO BOX 37428, RALEIGH, NC, 27627, US

(21) Appl. No.: 10/160,600

(22) Filed: May 31, 2002

(51) Int. Cl. G06K 9/68

(52) U.S. Cl. 382/219

(57) ABSTRACT

A handwritten symbol from a user is sensed and compared to a predetermined set of known symbols. A first one of the known symbols which corresponds to the sensed handwritten symbol is displayed to the user. In response to receiving an indication from the user that the displayed first known symbol does not correspond to the handwritten symbol, a second one of the known symbols which corresponds to the sensed handwritten symbol is selected and displayed to the user.

### BACKGROUND OF THE INVENTION

1. Technical Field

The present invention relates to handwriting recognition apparatus and methods and more particularly, to apparatus and methods for editing handwritten symbols.

2. Description of the Related Art

Many computer systems have been introduced that rely on a pen and digitizer pad combination, instead of or in addition to a keyboard, to interface with the computer system. The pen and digitizer pad combination can work particularly well for portable computer systems, such as palmtop computers or cellular phones with integrated personal digital assistant (PDA) functionality, since the arrangement allows a user to hold the portable computer system in one hand while writing onto the digitizer pad with the other hand. Often these pen-based computer systems provide handwriting recognition whereby the user can write on the digitizer pad and the device converts the user's handwriting into a machine readable format.

Unfortunately it may be difficult to accurately recognize handwritten letters since the handwriting style of users can vary tremendously and the accuracy of the digitizer pad may be balanced against pressures to provide low-cost solutions. This difficulty can become particularly apparent for complex character sets such as those used for the Japanese and Chinese written languages.

### SUMMARY OF THE INVENTION

According to some embodiments of the present invention, a symbol provided by a user is sensed and compared to a set of known symbols. A first one of the known symbols which may correspond to the sensed symbol is selected and displayed to the user. In response to receiving an indication from the user that the displayed first known symbol does not correspond to the provided symbol, a second one of the known symbols which may correspond to the sensed symbol is selected and displayed to the user. In this manner, a user may be provided with an alternative candidate symbol when a displayed symbol does not correspond to a desired symbol.

In other embodiments, the user may be simultaneously provided with a plurality of alternative candidate known symbols from which the user may select a known symbol and substitute it for the first known symbol. The first known symbol may be selected as corresponding most closely to the sensed symbol and the second known symbol may be selected as corresponding next most closely to the sensed symbol. The first known symbol may be selected by scoring the relative closeness of the sensed symbol to the set of known symbols. The scores may be stored and reused to select the second one of the known symbols.

In this manner, apparatus, methods, and computer program products may be provided that facilitate editing of symbols provided by a user, such as symbols which are handwritten by a user.

### BRIEF DESCRIPTION OF THE DRAWINGS

FIG. 1 illustrates a wireless mobile terminal including a pen and digitizer pad according to some embodiments of the present invention.

FIG. 2 illustrates a block diagram of a symbol recognition and display circuit in the wireless mobile terminal of FIG. 1 according to some embodiments of the present invention.

FIG. 3 illustrates operations of the symbol recognition and display circuit of FIG. 2 according to some embodiments of the present invention.

FIG. 4 illustrates editing operations for a symbol recognition and display circuit according to some embodiments of the present invention.

FIG. 5 illustrates editing operations for a symbol recognition and display circuit according to other embodiments of the present invention.

### DETAILED DESCRIPTION

The present invention will now be described more fully with reference to the accompanying drawings, in which typical embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

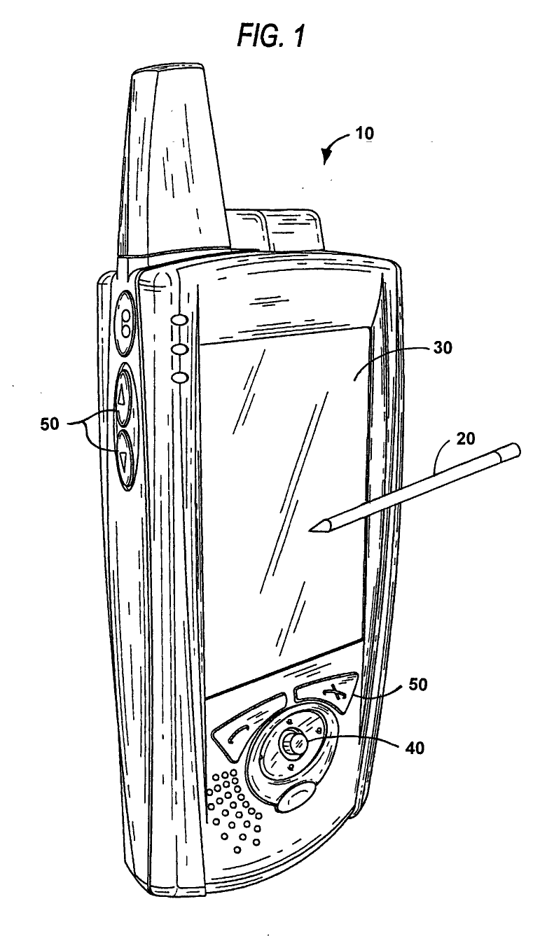

According to some embodiments of the present invention, symbol recognition apparatus and methods may be provided. FIGS. 1-5 are diagrams illustrating exemplary apparatus and operations according to embodiments of the present invention. It will be understood that operations depicted in the diagrams, and combinations thereof, may be implemented using one or more electronic circuits, such as circuits included in a component of a computer interface which uses handwriting or other symbol recognition. It will also be appreciated that, in general, operations depicted in the diagrams, and combinations thereof, may be implemented in one or more electronic circuits, such as in one or more discrete electronic components, one or more integrated circuits (ICs) and/or one or more application specific integrated circuits (ASICs) and/or application specific circuit modules, as well as by computer program instructions which may be executed by a computer or other data processing apparatus, such as a microprocessor or digital signal processor (DSP).

The computer program instructions may also be embodied in the form of a computer program product in a computer-readable storage medium, i.e., as computer-readable program code embodied in the medium for use by or in connection with an instruction execution system. The computer-readable storage medium may include, but is not limited to, electronic, magnetic, optical or other storage media, such as a magnetic or optical disk or an integrated circuit memory device. Accordingly, FIGS. 1-5 support electronic circuits and other apparatus that perform the specified operations, acts for performing the specified operations, and computer program products configured to perform the specified operations.

Referring to FIG. 1, a wireless mobile terminal 10 according to some embodiments of the present invention can include a pen 20, a touch sensitive display 30, a pointer stick 40, and switches 50. A user can write symbols with the pen 20 on the touch sensitive display 30. Written symbols are digitized and symbol recognition is performed on each digitized symbol to select a known symbol that is displayed to the user on the display 30. The touch sensitive display 30 can be divided between a symbol input area and a symbol display area or a combined area for input and display may be provided. A symbol input area can have separate areas in which individual symbols are written or a continuous symbol area in which a string of symbols can be written. Strings of symbols may be recognized together by the terminal 10 or first parsed into separate symbols and then recognized individually. Design and operation of a wireless mobile terminal as described in this paragraph is well known to those having skill in the art and will not be described further herein.

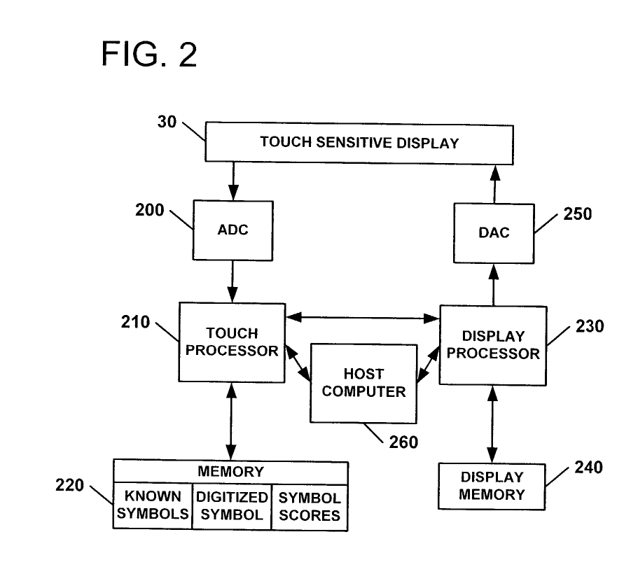

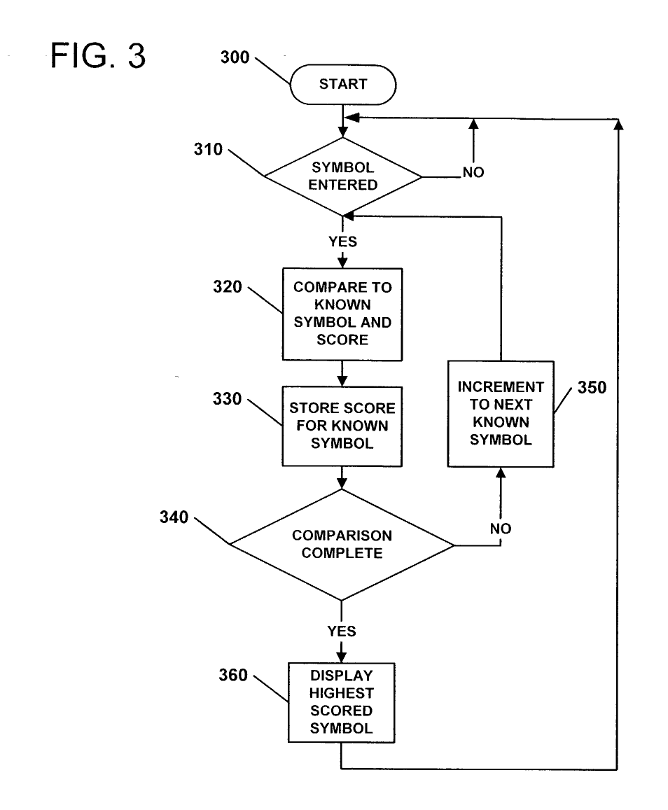

FIG. 2 illustrates a symbol recognition and display circuit according to some embodiments of the present invention. FIG. 3 illustrates a flowchart of the operations for receiving, recognizing, and displaying written symbols on, for example, the touch sensitive display 30 according to some embodiments of the present invention or another computer interface.

Upon power-up or activation of the symbol recognition circuit at Block 300, the symbol recognition circuit waits for a symbol to be written on a symbol input area of a touch sensitive display, such as the touch sensitive display 30 of FIG. 1. A written symbol is digitized by an analog-to-digital converter (ADC) 200 and passed to a touch processor 210. The touch processor 210, at Block 320, compares the digitized written symbol to a predetermined list of known symbols in a symbol memory 220 to identify a known symbol that may correspond to the digitized written symbol. Such symbol recognition may be performed using well known conventional symbol recognition algorithms. In some embodiments, the comparison may be made to identify the known symbols which most closely correspond to the digitized written symbol. The predetermined list of known symbols can represent any defined symbols, including a portion or all of a written alphabet, graphical representations of objects, or user-defined symbols. In some embodiments, a score is generated by the comparison which represents the closeness of the match. Tied scores may be resolved, for example, by selecting among the corresponding symbols based upon their relative position within the list of known symbols or based upon their relative frequency of use.

At Block 330, the digitized written symbol and the score from the comparison with the known symbol are stored. In some embodiments, they may be stored by the touch processor 210 in the memory 220. The comparing and storing, Blocks 320 and 330, are repeated though a loop of Blocks 340 and 350 until the digitized written symbol has been sequentially compared to all, or a portion, of the list of known symbols. Instead of storing each score from the comparison at Block 330, the stored scores may be a plurality of the highest scores or the scores that exceed a predetermined absolute threshold value. When the comparison and storing is completed, the highest score may indicate which one of the known symbols matched the digitized written symbol most closely.

At Block 360, the known symbol having the highest score is displayed. For example in the embodiments of FIG. 2, that known symbol may be passed to a display processor 230, stored in a display memory 240, converted by a digital-to-analog converter (DAC) 250 to an analog signal and displayed on the touch sensitive display 30 to the user. The known symbol can also be passed to a host computer, such as a host computer 260 illustrated in FIG. 2, for further processing.

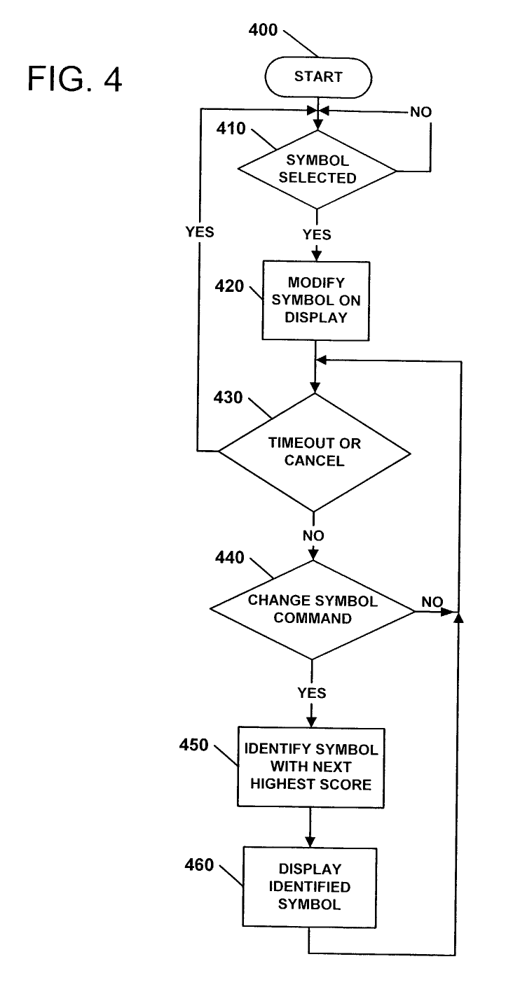

After viewing a displayed symbol or string of symbols a user may decide that one or more of the displayed symbols do not correctly match the desired written symbol. Editing a displayed symbol according to some embodiments of the present invention is shown in FIG. 4. A user can use the pen 20 to touch a symbol on the display 30 and cause it to be edited. Alternatively, a user can select a displayed symbol for editing by navigating among the displayed symbols using the pointer stick 40 (by applying pressure in a column or row direction relative to the displayed symbols or by rotational inputs to scroll through displayed symbols), switches 50, or a combination thereof. A user may also select a displayed symbol by navigating a cursor or other indicia among displayed symbols and pausing for at least a predetermined time on a desired one of the symbols. In some embodiments, when a symbol is selected for editing, a start-editing loop illustrated by Blocks 400 and 410 is exited, and the selected symbol is visually modified, at Block 420, to indication to the user that the symbol has been selected for editing. The selected symbol may be visually modified by, for example, providing a graphical highlight to the symbol, an underscore, reversing the color of the symbol and its background, or flashing the symbol.

After a displayed symbol has been selected for editing, a user can cancel the editing mode by providing a predetermined command with the pen 20, stick 40, and/or switches 50 or by providing no input for a predetermined timeout period, in which case the operations return from Block 430 to the waiting loop of Blocks 400 and 410. When editing is cancel or otherwise ended, the visual modification of the symbol, provided at Block 420, is undone. When the user provides a change symbol command (such as by the pen 20, stick 40, and/or switches 50) at Block 440, Block 450 retrieves from memory the next closest known symbol to the selected displayed symbol (next highest scored symbol) and passes the next closest known symbol for display at Block 460, such as by the display processor 230 on the display 30, in place of the selected displayed symbol.

Alternatively, the next closest known symbol can be identified by comparing the digitized written symbol corresponding to the selected displayed symbol, and stored in memory 220, with each of the known symbols, also stored in memory 220, to identify the next closest known symbol. In this manner, the scores developed for each comparison of the digitized written symbol to the known symbols need not be saved and stored in the memory 220 for each displayed symbol, such as was described for Block 330 of FIG. 3.

The operations loop then back to Block 430 to wait for another change symbol command at Block 440. When the displayed symbol is still not correct, the user provides another change symbol command and the operations illustrated by Blocks 440-460 are repeated. When the displayed symbol is correct or when the user otherwise desires to cancel the symbol edit mode, the user can either cancel the mode by providing a predetermined command or allow the operations to timeout at Block 430. In this manner, incorrect displayed symbols may be efficiently replaced with a known symbol which correctly corresponds to the user's desired written symbol.

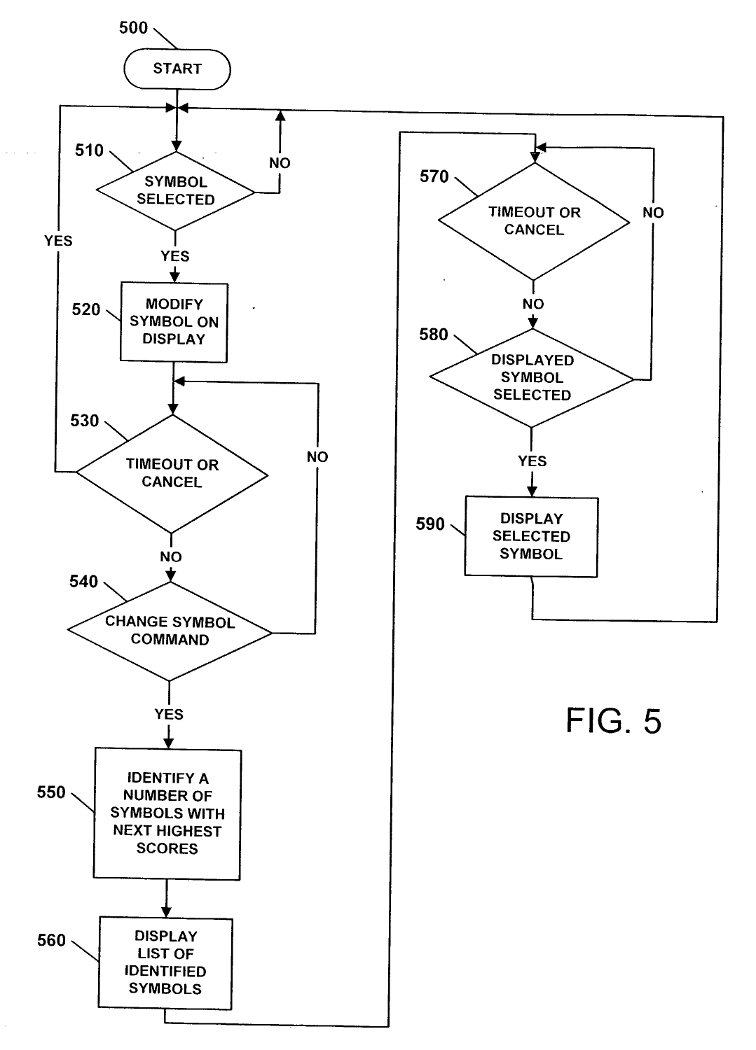

With reference now to FIG. 5, editing a displayed symbol according to other embodiments of the present invention is shown. When a user selects a symbol for editing, a list of next closest known symbols is displayed and the user can select from among the list. The operations begin by waiting at Blocks 500 and 510 for a displayed symbol to be selected. The operations by which a user may select a displayed symbol can include those described for Block 410 in FIG. 4. A selected symbol may be visually modified at Block 520. The user can cancel the editing or allow it to timeout, at Block 530, or can provide a change symbol command at block 540 to indicate a desire to see alternative next closest symbols to the selected symbol. In response to the change symbol command, a plurality of the next closest known symbols to the digitized written symbol are retrieved at Block 550 and displayed at Block 560. The operations at Block 550 of identifying a list of next closest symbols can be similar to that described for Block 450 of FIG. 4 to select a single closest known symbol. The user can cancel the editing command or allow a timeout, at Block 570, to leave the selected displayed symbol unchanged or can select one of the displayed list of next closest known symbols, Block 580, to cause the known symbol selected from the list to be substituted for display in the place of the symbol selected for editing, at Block 590.

While the symbol recognition circuits and operations have been described with regard to the mobile terminal 10, it will be appreciated to one skilled in the art that they may be embodied in any handwriting recognition apparatus such as those used in user interfaces for computer systems, portable computers, and personal digital assistants (PDA). Moreover, the handwriting interface may be integrated with the display, such as with a touch sensitive display, or may be separate from the display, such as a writing pad that digitizes pen movements.

In the drawings and specification, there have been disclosed typical embodiments of the invention and, although specific terms are employed, they are used in a generic and descriptive sense only and not for purposes of limitation, the scope of the invention being set forth in the following claims.

That which is claimed:

1. A method of operating a symbol recognition system for a set of known symbols, the method comprising:
sensing an indication of a desired symbol;
selecting a first one of the known symbols which may correspond to the desired symbol;
displaying the first one of the known symbols;
receiving an indication that the displayed first one of the known symbols does not correspond to the desired symbol;
selecting a second one of the known symbols which may correspond to the desired symbol; and
displaying the second one of the known symbols.

2. A method according to claim 1, further comprising:
providing as the set of known symbols a predetermined set of individual characters representing at least a portion of a written alphabet.

3. A method according to claim 1, wherein selecting a first one of the known symbols comprises:
selecting a first one of the known symbols which most closely corresponds to the desired symbol.

4. A method according to claim 3, wherein the selecting a second one of the known symbols comprises:
selecting a second one of the known symbols which has the next closest correspondence to the desired symbol.

5. A method according to claim 1, wherein the selecting a first one of the known symbols comprises:
developing a score indicative of the closeness of a comparison of the desired symbol to each of the predetermined set of known symbols.

6. A method according to claim 5, further comprising:
storing a plurality of the scores from the comparisons of the desired symbol to each of the predetermined set of known symbols.

7. A method according to claim 6, wherein the selecting a second one of the known symbols comprises:
selecting a second one of the known symbols based upon the stored scores from the comparisons.

8. A method according to claim 5, further comprising:
storing scores, which exceed a predetermined threshold value, from the comparisons of the desired symbol to each of the predetermined set of known symbols.

9. A method according to claim 8, wherein the selecting a second one of the known symbols comprises:
selecting a second one of the known symbols based upon the stored scores from the comparisons.

10. A method according to claim 1, wherein the selecting a second one of the known symbols comprises:
developing a score indicative of the closeness of a comparison of the desired symbol to the predetermined set of known symbols.

11. A method according to claim 1, wherein the displaying the second one of the known symbols is followed by receiving an indication from the user that the displayed second one of the known symbols does not correspond to the desired symbol.

12. A method according to claim 11, further comprising:
selecting a third one of the known symbols which corresponds to the desired symbol; and
displaying the third one of the known symbols to the user.

13. A method according to claim 1, further comprising:
receiving an indication from the user that the displayed second one of the known symbols corresponds to the desired symbol; and
substituting the second one of the known symbols for the displayed first one of the known symbols.

14. A method according to claim 1, wherein:
the selecting a second one of the known symbols further comprises selecting a plurality of the known symbols which correspond to the desired symbol; and
the displaying the second one of the known symbols further comprises displaying the selected plurality of known symbols to the user.

15. A method according to claim 14, further comprising:
receiving a selection indication from the user of one of the displayed plurality of known symbols; and
displaying the selected one of the displayed plurality of known symbols without the non-selected ones of the plurality of known symbols.

16. A method according to claim 1, further comprising:
modifying the displayed first one of the known symbols in response to receiving an indication from the user that the displayed first one of the known symbols does not correspond to the desired symbol.

17. A symbol recognition apparatus, comprising:
a memory that is configured to store a predetermined set of known symbols;
a symbol sensing circuit that senses an indication of a desired symbol;
a symbol selection circuit that is operative to compare the desired symbol to the known symbols and output a first one of the known symbols that corresponds to the desired symbol and, in response to receiving a command, output a second one of the known symbols that corresponds to the desired symbol; and
a display circuit that displays the known symbol output by the symbol selection circuit.

18. A symbol recognition apparatus according to claim 17, wherein the symbol selection circuit is operative to select a first one of the known symbols which most closely corresponds to the desired symbol.

19. A symbol recognition apparatus according to claim 18, wherein the symbol selection circuit is operative to select a second one of the known symbols which next most closely corresponds to the desired symbol.

20. A symbol recognition apparatus according to claim 17, wherein the symbol selection circuit is operative to score the closeness of the comparison of the desired symbol to the known symbols.

21. A symbol recognition apparatus according to claim 20, wherein the symbol selection circuit is operative to store in the memory at least a plurality of the scores from the comparisons of the desired symbol to the known symbols.

22. A symbol recognition apparatus according to claim 21, wherein the symbol selection circuit is operative, in response to receiving an edit command from a user, to select and output the second one of the known symbols based upon the scores stored in the memory.

23. A symbol recognition apparatus according to claim 17, wherein the symbol selection circuit is operative, in response to receiving an edit command from a user, to compare the desired symbol to the known symbols and output the second one of the known symbols.

24. A symbol recognition apparatus according to claim 17, wherein the symbol selection circuit is operative, in response to receiving an edit command from a user while the display circuit displays the second one of the known symbols, to output a third one of the known symbols that corresponds to the desired symbol.

25. A symbol recognition apparatus according to claim 17, wherein:
the symbol selection circuit is operative, in response to receiving an edit command from a user, to select and output a plurality of the known symbols which correspond to the desired symbol; and
the display circuit is operative to display the plurality of the known symbols output by the symbol selection circuit.

26. A symbol recognition apparatus according to claim 25, wherein:
the symbol selection circuit is operative, in response to receiving a command from a user selecting one of the displayed plurality of the known symbols, to output only the selected one of the displayed plurality of the known symbols.

27. A symbol recognition apparatus according to claim 17, wherein:
the symbol selection circuit is operative to modify the displayed first one of the known symbols in response to receiving an edit command from a user.

28. A computer program product for operating a symbol recognition apparatus for a set of known symbols, the computer program product comprising program code embodied in a computer-readable storage medium, the computer program code comprising:
program code for sensing an indication of a desired symbol;
program code for selecting a first one of the known symbols which may correspond to the desired symbol;
program code for displaying the first one of the known symbols;
program code for receiving an indication that the displayed first one of the known symbols does not correspond to the desired symbol;
program code for selecting a second one of the known symbols which may correspond to the desired symbol; and
program code for displaying the second one of the known symbols.

29. A computer program product according to claim 1, wherein the program code for selecting a first one of the known symbols comprises:
program code for selecting a first one of the known symbols which most closely corresponds to the desired symbol.

30. A computer program product according to claim 29, wherein the program code for selecting a second one of the known symbols comprises:
program code for selecting a second one of the known symbols which most closely corresponds to the desired symbol.

31. A computer program product according to claim 28, further comprising program code for receiving an indication from the user that the displayed second one of the known symbols does not correspond to the desired symbol.

32. A computer program product according to claim 31, further comprising:
program code for selecting a third one of the known symbols which corresponds to the desired symbol; and
program code for displaying the third one of the known symbols to the user.

33. A computer program product according to claim 28, further comprising:
program code for receiving an indication from the user that the displayed second one of the known symbols corresponds to the desired symbol; and
program code for substituting the second one of the known symbols for the displayed first one of the known symbols.

34. A computer program product according to claim 28, further comprising:
program code for selecting a plurality of the known symbols which correspond to the desired symbol; and
program code for displaying the selected plurality of known symbols to the user.

35. A computer program product according to claim 24, further comprising:
program code for receiving a selection indication from the user of one of the displayed plurality of known symbols; and
program code for displaying the selected one of the displayed plurality of known symbols without the non-selected ones of the plurality of known symbols.
